(19) United States
(12) Patent Application Publication
(10) Pub. No.: US 2003/0129560 A1
(43) Pub. Date: Jul. 10, 2003

(54) Rotatable dental jet nozzle

(76) Inventors: Benjamin Atkin, Miami, CA (US); Joseph Leal, Suiten Santa Clarita, CA (US)

Correspondence Address: Henry I. Schanzer, 29 Brookfall Road, Edison, NJ, 08817, US

(21) Appl. No.: 10/283,479

(22) Filed: Oct. 30, 2002

Related U.S. Application Data
(60) Provisional application No. 60/335,647, filed on Oct. 31, 2001.

(51) Int. Cl. A61C 3/02

(52) U.S. Cl. 433/88

(57) ABSTRACT

A dental tool embodying the invention includes a handpiece into which is inserted a shaft on which is mounted a head portion which extends above the top of the handpiece. The head portion includes first and second input channels which are merged into an output channel for discharging a gas, powder and liquid mixture obtained from mixing the materials supplied to the input channels. A rotatable nozzle is mounted directly or via a swivel arrangement on the head portion so as to provide a conduit from the output channel to teeth to be cleaned. The nozzle may be rotated by a dental practitioner using any of the fingers of the hand holding the handpiece to apply a force directly to the nozzle or to a swivel arrangement coupling the nozzle to the head. The head portion may be formed of an inexpensive material, such as plastic, so the nozzle and/or the head portion may be discarded after being used, without excessive cost.

### BACKGROUND OF THE INVENTION

This invention relates to an improved dental tool for aiding in the cleaning and polishing of surfaces (e.g., teeth) within an oral cavity (e.g., mouth).

The use of hand held dental tools to clean, polish and/or remove unwanted materials from teeth is known. Many of these tools operate by mixing a gaseous stream (e.g., compressed air) mixed with an abrasive powder and then further mixing the gas/powder combination with a liquid (e.g., water). The entire mixture of gaseous stream combined with the abrasive powder and the liquid may then be selectively directed onto a tooth surface to be cleaned. The entire mixture of gas powder and liquid (i.e., “cleaning stream”) is typically discharged on a tooth through a nozzle attached to the hand held dental tool upon activation of the tool by an operator.

Known tools include a nozzle which is fixedly mounted on a handpiece. During operation the dental practitioner may need to redirect or reorient the location of the nozzle to direct the “cleaning stream” from one tooth to another. In order to accomplish this task the dental practitioner needs to twist his/her wrist, which may not be comfortable or feasible. Alternatively, the dental practitioner needs to remove the tool from the oral cavity and reposition the tool in his/her hand when going from one tooth to another tooth. This presents problems since the repositioning of the tool may cause unacceptable twisting of those tubes attached to the tool, which carry air/powder and liquid.

Another problem is that known nozzles are normally formed of metals and materials which are relatively expensive. Because of their high cost, the tools have to be sterilized after each use, since it is not cost effective to discard such tools after each use.

Accordingly, there is a need for a dental tool which overcomes the problems discussed above.

### SUMMARY OF THE INVENTION

A hand held dental tool embodying the invention includes a nozzle mounted on the tool in such a manner that the direction or orientation of the nozzle may be changed without the need to alter the position of the hand/wrist of the dental practitioner holding the tool and without the need to reposition the tool in the hand of its user.

In one embodiment, the dental tool includes a shaft having a bottom end and a top end with a head portion mounted on the top end of the shaft. The head portion has a back end and a front end. The head portion includes two input channels which extend from the back end and which merge into a single output channel which exits and discharges from the front end of the head portion. One of the two input channels is for passing a gas and a powder mixture and the other input channel is for passing a liquid. The output channel is for passing a mixture of the gas, powder and liquid and discharging the mixture out of the front end. A selectively rotatable nozzle is attached to the output channel at the front of the head for enabling a user to selectively rotate the nozzle by using his/her fingers to apply a force to the nozzle. Thus, the nozzle may be reoriented or redirected without having to change the orientation of the tool or moving the user's hand/wrist. In one embodiment the nozzle is attached to the front of the head via a ball swivel mechanism so it can be rotated from one orientation to another. In another embodiment the nozzle is formed of a semi rigid material for enabling a user to selectively bend and set the nozzle from a first position to a second position; but the nozzle material is selected to be sufficiently rigid to maintain the position into which it was bent and set.

A dental tool embodying the invention includes a handpiece having a generally cylindrical shell with a top and a bottom and a central cavity extending from its top to its bottom. A shaft, of the type described above, is inserted within the central cavity, with the bottom end of the shaft being inserted toward the bottom of the handpiece and a head portion, of the type described above, attached to the top end of the shaft extending above the top of the handpiece. A first tube for carrying a gas and a powder (e.g., compressed air and an abrasive powder) is positioned within the handpiece and extends along the handpiece to one of two input channels of the head portion. A second tube for carrying a liquid (e.g., water) is positioned within the handpiece and extends along the handpiece to the other one of the two input channels. The nozzle, rotatably mounted on the front of the head portion, may be reoriented or redirected by the operator holding the handpiece in one of his/her hands and using fingers of that hand to apply a force to the nozzle. Thus, the nozzle may be selectively redirected or rotated without causing any substantial twisting of the first and second tubes and without requiring the hand/wrist of the dental practitioner to be moved or the position of the handpiece to be changed.

In accordance with one aspect of the invention, the nozzle and/or the head may be formed of a plastic like material, whose cost is significantly less than presently available tools, such that the nozzle may be disposed of and discarded after each use.

### BRIEF DESCRIPTION OF THE DRAWINGS

In the accompanying figures like reference characters denote like components; and

FIG. 1 is a plan view of a tool embodying the invention;

FIG. 2 is a cross sectional view of a tool embodying the invention;

FIG. 2A is an enlarged view of the ‘swivel’ portion and the nozzle of a tool embodying the invention;

FIG. 3 is a cross sectional diagram of the shaft of a tool which can be used to practice the invention;

FIG. 4 is a cross section diagram of a handpiece (jacket) into which a tool embodying the invention may be mounted;

FIG. 5 is a cross sectional diagram of a tool embodying the invention mounted within the handpiece of FIG. 4.

FIG. 6 is a cross sectional diagram of a head portion embodying the invention for use in dental tools embodying the invention;

FIG. 7 is a more detailed cross section of a swivel mechanism for use in a tool embodying the invention;

FIG. 8 is a cross-sectional diagram of a deformable nozzle mounted in a head portion in accordance with the invention;

FIGS. 9 and 9A are a cross section diagram and an isometric drawing, respectively, of a nozzle with a spherical half-shell at its distal end for providing rotation when mounted in a head portion in accordance with the invention; and

FIG. 10 is a cross section diagram of a head portion and nozzle in accordance with the invention in which two input channels merge into one output channel.

### DETAILED DESCRIPTION OF THE INVENTION

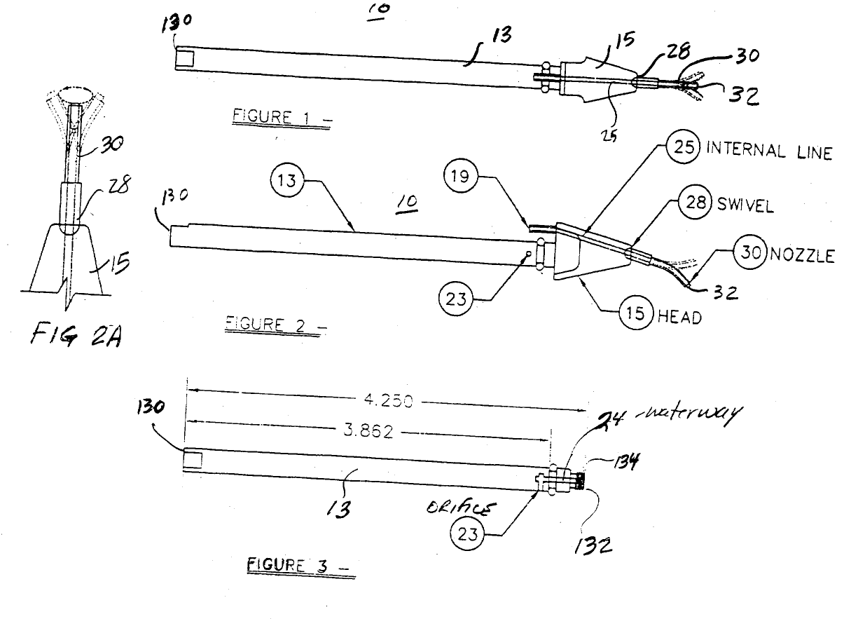

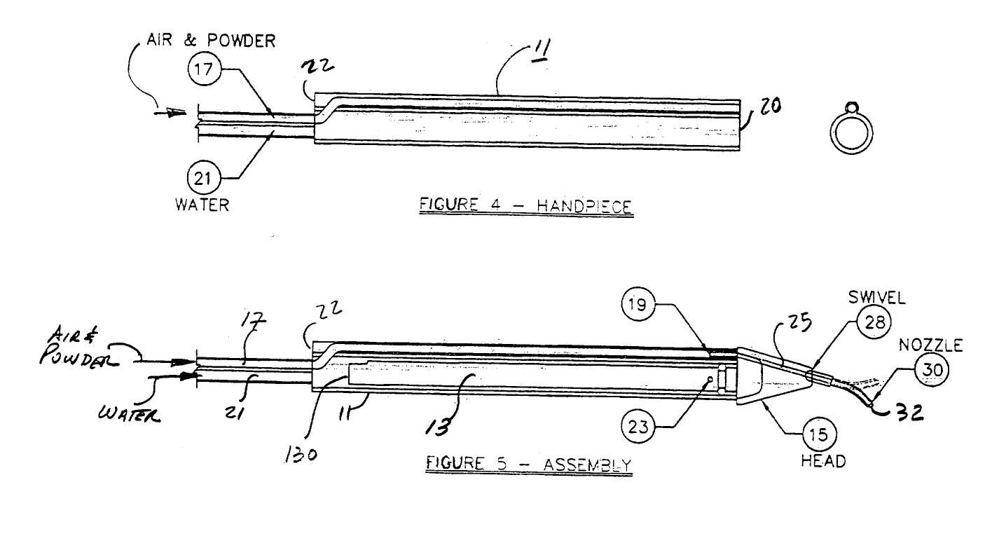

FIG. 1 is a plan view and FIG. 2 is a cross sectional view of a dental tool 10 which may be used to deliver particles of any suitable material (e.g., abrasive material or any other powder) to a surface (e.g., of a tooth in an oral cavity) to be cleaned. Suitable materials for cleaning teeth include a mixture of air, powder and water. The tool 10 includes a shaft portion 13 having a bottom end 130 and a top end 132 (see FIG. 3) to which is connected a head portion 15 which in turn is coupled via a swivel arrangement 28 to a nozzle 30. The top end of the shaft 13 may include a threaded section 134 (See FIG. 3) for enabling the head portion 15 to be screwed onto the top end of the shaft and to thereby be fixedly mounted on the shaft. The head 15 may be attached to the shaft in any other suitable manner. The tool 10 (shown in FIGS. 1, 2, and 3) fits into a handpiece (“jacket”), 11, shown in FIG. 4 to form an assembly of the type shown in FIG. 5. The handpiece or jacket 11 has a top end 20 and a bottom end 22.

A tube 17 (see FIGS. 4 and 5) for carrying air and/or powder extends from the bottom end 22 of the jacket to the top end 20 of the jacket 11. The tube 17 is connected at its top to a pip 19 extending rearwardly from the head 15 so as to deliver the air and/or powder via the pip 19 to conduit 27, 25 in the head 15. The rear end of tube 17 is connected to a source (not shown) of air and/or powder.

Another tube 21 for carrying a jet of water is also located within the handpiece and extends along the length of the handpiece. Tube 21 carries the water from a source (not shown) and within the jacket for delivery to and into an orifice 23 (see FIGS. 3 and 5) formed in the upper front portion of the shaft 13 near the head 15. The orifice 23 feeds into one end of a waterway 24, formed in the top portion of the shaft (see FIG. 3), to enable water to discharge within the head 15 and via the swivel arrangement 28 into the nozzle 30.

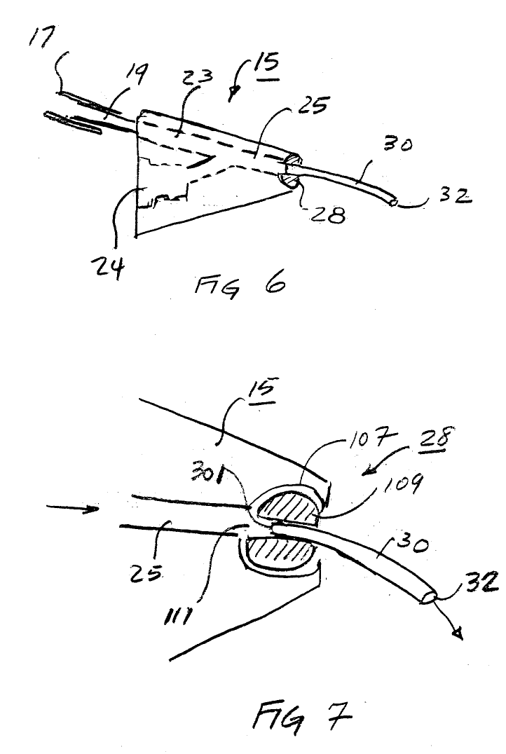

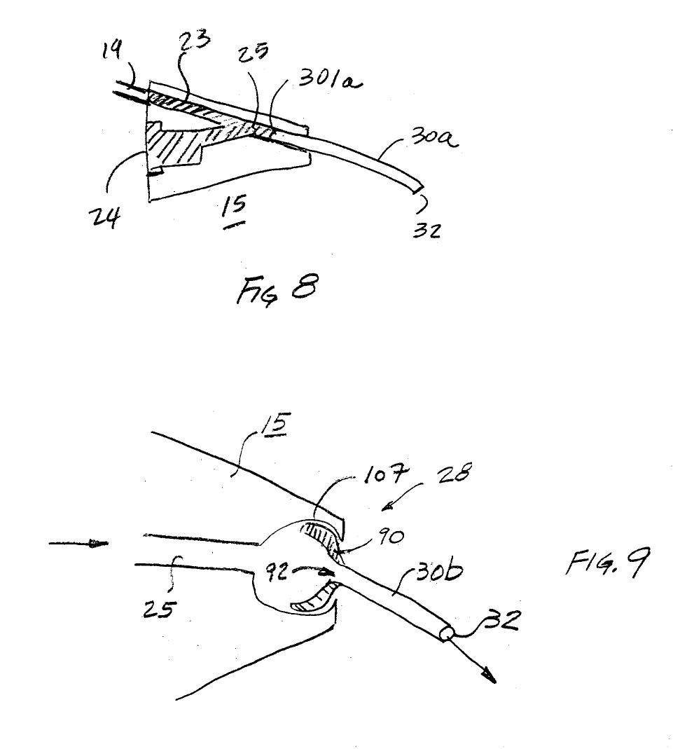

The air and/or powder are blown (or injected) into the head 15 via an internal tube 25 which extends from the pip 19 into the head 15. In one embodiment the internal tube 25 extends to the swivel region and from the swivel region into nozzle 30. Water is also injected into the head from orifice 23 and via waterway 24. The air/powder and the water then flow via the swivel arrangement into the nozzle 30. The nozzle 30 may extend 1 to 3 (or more) inches from the head and is made with a bend (or is bendable) to have a rigid and firm shape. The end, tip 32, of the nozzle 30 distal from the head 15 is intended to be applied to a surface (e.g., a tooth or other like surface normally within an oral cavity) to be cleaned or worked upon. The end of the nozzle, proximal to the head 15, is attached to the head via a swivel arrangement which enables the nozzle to “swivel” 360 degrees. The swivel arrangement (See FIGS. 6, 7, 9 and 9A) enables a user (dentist or dental hygienist) of the tool to clean a first selected surface and to then clean a second selected surface by applying a force to the nozzle and/or to the swivel arrangement with a finger (e.g., the index or middle finger) of the hand holding the handpiece. Thus, the direction of the spray coming out of the nozzle can be changed without having to change the orientation of the tool 10 and twisting the tubes attached to the tool or movement of the wrist. This process may be repeated several times. This is a significant improvement as it avoids the need to move the operator's wrist or to twist the tubes bringing air/powder/water into the head 15. Note that the swivel arrangement is such that the nozzle once rotated to a selected position will remain in that position, until forcibly moved or changed by a user to a different or new position.

An enlarged view of a swivel mechanism embodying the invention is shown in FIG. 2A. The front end of the head 15 is shaped to accommodate the swivel mechanism 28 and to allow for “swiveling” while at the same time ensuring that once the nozzle 30 is set to a particular position it remains set in that position while a user is handling the tool 10 mounted within its jacket 11.

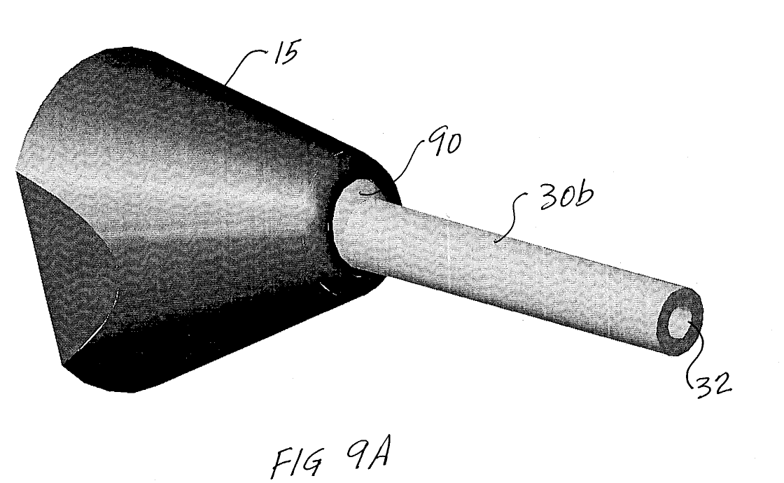

FIGS. 6 and 7 show further details of a swiveling arrangement 28 and the passageways within the head 15. Referring to FIG. 6, note that at the rear end of head 15 there are two input channels generally identified by a pip 19 and an input 24 which extends from shaft 13. Thus, one input channel includes a pip 19 over which is mounted one end of tube 17. The pip 19 is coupled to a first conduit 27, within the head 15, which may be used to carry, for example, air and powder from the back of the head to the front of the head and then into the nozzle 30. A second input channel (conduit 24) may be used to carry a liquid (e.g., water). The two input channels merge into a single output channel (conduit 25) which carries the combined “cleaning stream” to the nozzle 30 via a swiveling arrangement 28.

A more detailed version of a portion of a swiveling arrangement is shown in FIG. 7. The tube 25 terminates in a spherical socket 107. A ball 109, for providing rotation, is mounted within the socket. The ball 109 has a central cylindrical cut out 111 which is aligned with the opening of tube 25 whereby the stream flowing through tube 25 can freely pass through passageway 111 into nozzle 30. The socket 107 has a small lip to hold the ball 109. The ball may be inserted into the socket by being press fitted, or snapped into place, or by any other suitable means. The distal end 301 of nozzle 30 may be inserted into the passageway 111. To keep the nozzle in place within the ball, the insertion of nozzle 301 may be by a force fit or a threading arrangement or by a keying arrangement.

In operation, a dental practitioner may apply pressure to the nozzle by using the fingers of his/her hand to apply a force to the nozzle or swivel mechanism to cause the nozzle to rotate to assume a “new” desired position. The dental practitioner can then work on a tooth at the desired position. Thus, the dental practitioner can change the orientation or direction of the nozzle by extending his/her index finger and applying pressure to the nozzle and/or the swiveling arrangement. Of course, the dental practitioner may also use both hands. However, it should be understood that the change in orientation or direction of the nozzle of dental tools embodying the invention can be easily negotiated using just one hand and possibly just one finger of a hand.

Another aspect of the invention is shown in FIG. 8. In accordance with this aspect of the invention, the nozzle 30a is formed of a semi-rigid material (e.g., a bendable plastic) whose shape can be altered by the application of some force directly to the nozzle. However, once bent, the nozzle 30a will maintain the imparted shape until a counter force is again applied to again change its shape. Where the shape of nozzle 30a can be readily altered the need for a swiveling arrangement may not be necessary. Thus, the distal end 301a of a nozzle of the type such as nozzle 30a may be force fitted at its distal end into the tube 25 or it may be mounted on a swiveling arrangement as described above.

FIGS. 9 and 9A illustrate that the passageway 25 in head 15 can terminate in a socket 107, as shown in FIG. 7. However, in FIGS. 9 and 9A, the end of nozzle 30b that fits into the head section is shaped to form a spherical half-shell 90 which can be snapped-in or press fitted into socket 107. The spherical half-shell 90 fits snuggly in the spherical socket 107; but it can be moved with the application of a force to the nozzle and because of the snug fit, it will stay in the position to which it is moved by the operator until another force is applied. The spherical half-shell 90 has an opening 92 which provides a conduit from output channel 25 into nozzle 30b. The spherical half-shell enables the nozzle to be rotated through 360 degrees of rotation and to be swiveled over a very wide range.

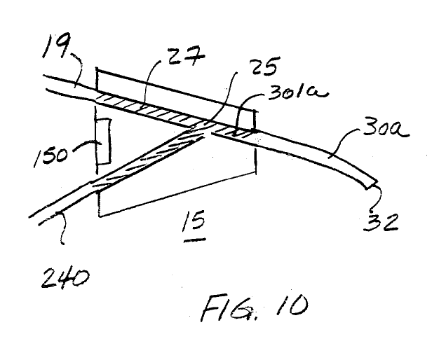

FIG. 10 shows that water need not come through an orifice 23 in the shaft and a passageway 24 extending through the shaft, as illustrated in the previous figures. FIG. 10 shows that gas and powder can be supplied to the head via to an input port 19 and that a liquid can be supplied via tube 21 to the head through an input port and conduit 240, where input port 240 is connected and merged with passageway 27 into passageway 25 for delivery to a nozzle either directly or via a swiveling arrangement. In FIG. 10 the head 15 is formed with a threaded bore 150 so it can be screwed onto a shaft. However it should be understood that the head can be mounted to the shaft by any other suitable mounting arrangements.

An important aspect of the tool 10 is that the head section 15 and/or the nozzle (30, 30a, 30b) can be made of a plastic material. So formed, the cost of manufacturing the head and/or the nozzle is much less than presently known metal parts. This feature makes it economically feasible to use a different head and/or nozzle per patient and to dispose of the head and/or nozzle after each use. This disposable tool is much more sanitary than presently known metal tools which, because of their cost, must be constantly reused. Furthermore, using a new tool for each new patient avoids a problem of clogging the passageways within the head and/or the nozzle experienced with presently known dental tools which are reused. Still further, using a disposable head eliminates the need to sterilize the nozzle and head after each use, which requires the removal of the head after each use and the need to reinsert the head into a jacket after each use. These procedures are time consuming and often difficult to accomplish so that an air tight and water tight arrangement is achieved. Thus the tool embodying the invention provides significant advantages over prior art tools.

What is claimed is:

1. A dental tool for cleaning teeth comprising:
a shaft having a rear end and a front end;
a head portion mounted on the front end of the shaft, the head portion having a back end and a front end; the head including two channels extending from the back end and merging into a channel exiting from the front end of the head portion; one of the two channels for passing a gas and a powder mixture and the other channel for passing a liquid and the exiting channel for passing a mixture of the gas, powder and liquid; and a rotatable nozzle coupled to the exiting channel at the front of the head for selectively enabling a user to rotate the nozzle without having to change the orientation of the tool.

2. The dental tool as claimed in claim 1, wherein the rotatable nozzle is attached to the front of the head via a ball swivel mechanism.

3. The dental tool as claimed in claim 1, wherein the nozzle is formed of a semi rigid material for enabling a user to selectively bend the nozzle from a first position to a second position, but wherein the material is rigid enough to maintain the position into which it was bent.

4. The dental tool as claimed in claim 1, further including a handpiece having a top and a bottom and a central cavity extending from the top to the bottom of the handpiece, and wherein the shaft is inserted within the central cavity, with the rear of the shaft being inserted toward the bottom of the handpiece and the head portion extending above the top of the handpiece.

5. The dental tool as claimed in claim 4, wherein a first tube for carrying a gas and a powder is positioned within the handpiece and extends along the handpiece to said one of said two channels; and wherein a second tube for carrying a liquid is positioned within the handpiece and extends along the handpiece to said other one of said two channels; and wherein the nozzle may be rotated without causing any twisting of the first and second tubes.

6. The dental tool as claimed in claim 2 wherein there is a cutout within the ball swivel mechanism to provide a continuous passageway for the gas, powder and liquid from the exiting channel to the nozzle.

7. The dental tool as claimed in claim 2, wherein the nozzle is settable to different positions by applying a force to at least one of the nozzle and swivel mechanism.

8. The dental tool as claimed in claim 1, wherein the nozzle includes a distal end and a proximal end, the proximal end for application to the teeth to be cleaned and the distal end for coupling to the front end of the head portion, and the distal end being shaped generally like a spherical half-shell.

9. The dental tool as claimed in claim 8 wherein the exiting channel terminates in a socket like configuration into which the spherical half-shell fits snuggly.

10. A dental tool for cleaning teeth comprising:
a handpiece with a central cavity having a top and a bottom;
a shaft for insertion within the handpiece cavity a rod-like insert having a bottom end and a top end on which is mounted a head portion, with the head portion having a back end and a front end; the rod-like insert for insertion within the handpiece with the bottom of the insert toward the bottom of the handpiece and the head portion extending above the top of the handpiece; the head portion including a channel extending from the back of the head to the front of the head with a nozzle rotatably attached the front of the head and providing a continuous passageway from the channel to the nozzle.
